(19) United States
(12) Patent Application Publication
(10) Pub. No.: US 2008/0042571 A1
(43) Pub. Date: Feb. 21, 2008

(54) FILTER AND PLASMA DISPLAY DEVICE THEREOF

(75) Inventors: Hong Rae CHA, Seoul (KR); Ji Hoon SOHN, Seoul (KR); Sam Je CHO, Seoul (KR); Woo Sung JANG, Seoul (KR); Woon Seo SHIN, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/839,619

(22) Filed: Aug. 16, 2007

(30) Foreign Application Priority Data
Aug. 18, 2006 (KR) 10-2006-0078264
Nov. 6, 2006 (KR) 10-2006-0108664

(51) Int. Cl. H01J 17/49; G02F 1/01

(52) U.S. Cl. 313/582; 430/6

(57) ABSTRACT

The present invention relates to a filter and a plasma display device thereof, and the plasma display device includes a plasma display panel; and a filter formed at a front of the plasma display panel, wherein the filter includes external light shielding sheet which is provided with a base unit and a plurality of pattern units formed on the base unit and having a lower refractive index than a refractive index of the base unit, and wherein a cross sectional shape of at least one of the pattern units' edges is a curve.

According to the present invention, it is possible to effectively realize black images and enhance bright room contrast by arranging the external light shielding sheet, which absorbs and shields external light from the outside, at the front of the display panel. Also, it is possible to prevent the pattern units from being detached from the base unit due to external impact and to effectively shield external light incident upon the PDP from various directions by forming the edge portions or the bottom of the pattern units as a curve having a predetermined curvature.

### BACKGROUND OF THE INVENTION

1. Field of the Invention

The present invention relates to a plasma display device, and more particularly, to a plasma display device in which an external light shielding sheet is disposed at a front of a panel in order to shield external light incident upon the panel so that the bright room contrast of the panel is enhanced while maintaining the luminance of the panel.

2. Description of the Conventional Art

Generally, a plasma display panel (PDP) displays images including text and graphic images by applying a predetermined voltage to a plurality of electrodes installed in a discharge space to cause a gas discharge and then exciting phosphors with the aid of plasma generated as a result of the gas discharge. The PDP is easy to manufacture as large-dimension, light and thin flat displays. In addition, the PDP has advantages in that it can provide wide vertical and horizontal viewing angles, full colors and high luminance.

In the meantime, external light is reflected by a front surface of the PDP due to white phosphors that are exposed on a lower substrate of the PDP when the PDP displays black images. For this reason, the PDP may mistakenly recognize the black images as being brighter than they actually are, thereby causing contrast degradation.

### SUMMARY OF THE INVENTION

The present invention is derived to resolve the above problems of the prior art, and an object of the present invention is to provide a plasma display device capable of shielding external light incident upon the PDP and preventing light from being reflected so that the bright room contrast of the PDP is enhanced while maintaining the luminance of the PDP.

Another object of the present invention is to provide an external light shielding sheet for a plasma display device, which is strongly resistant to external heat and pressure.

To solve the above described problems, the plasma display device of the present invention includes a plasma display panel (PDP); and an external light shielding sheet which is disposed at a front of the PDP to shield external light incident upon the PDP.

The external light shielding sheet includes a base unit; and a plurality of pattern units that are formed on the base unit and have a lower refractive index than a refractive index of the base unit, wherein a cross sectional shape of at least one of the pattern units' edges is a curve.

According to another aspect of the present invention, there is provided a plasma display device for solving the above described problems, wherein a bottom of the pattern units of the external light shielding sheet has a curved groove.

There is provided a filter for solving the above described problems, including an external light shielding sheet having a base unit and a plurality of pattern units that are formed on the base unit and have a lower refractive index than a refractive index of the base unit, wherein a cross sectional shape of at least one the pattern units' edges is a curve.

### BRIEF DESCRIPTION OF THE DRAWING

FIG. 1 is a perspective view illustrating a structure of a plasma display panel according to an embodiment of the present invention.

FIG. 2 is a cross-sectional view schematically illustrating a structure of an external light shielding sheet according to an embodiment of the present invention.

FIGS. 3 to 6 are cross-sectional views illustrating optical property according to the structure of the external light shielding sheet.

FIGS. 7 to 19 are cross-sectional views illustrating a shape of the pattern units of the external light shielding sheet according to embodiments of the present invention.

FIGS. 20 to 25 are cross sectional views illustrating a cross sectional shape of the pattern units of concave profile at the bottom of the pattern units according to the embodiments of the present invention and explaining the optical property thereof.

FIG. 26 is a cross sectional view for explaining the relation between a distance of a pair of adjacent pattern units formed on the external light shielding sheet and a height of the pattern units.

FIGS. 27 to 30 are cross sectional views illustrating a structure of a filter having the external light shielding sheet according to the embodiments of the present invention.

### DETAILED DESCRIPTION OF THE PREFERRED EMBODIMENT

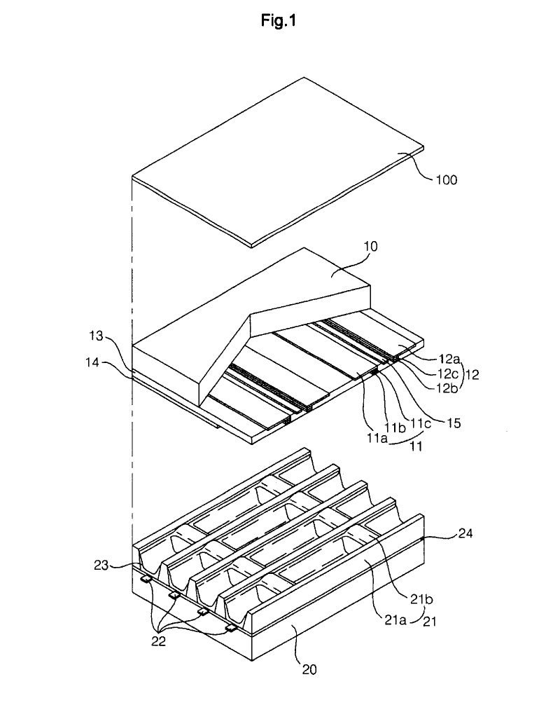

Hereinafter, the present invention will be described in detail with reference to the accompanying drawings, in which exemplary embodiments of the invention are shown. FIG.1 is a perspective view illustrating a plasma display panel according to an embodiment of the present invention.

As shown in FIG. 1, the PDP includes a scan electrode 11 and a sustain electrode 12, which are a sustain electrode pair formed on an upper substrate 10, and an address electrode 22 formed on a lower substrate 20.

The sustain electrode pair 11 and 12 includes transparent electrodes 11a and 12a and bus electrodes 11b and 12b that are generally made of indium-tin-oxide (ITO). The bus electrodes 11b and 12b can be made of a metal such as silver (Ag) and chrome (Cr) or can be made with a stacked structure of chrome/copper/chrome (Cr/Cu/Cr) or chrome/aluminum/chrome (Cr/Al/Cr). The bus electrodes 11b and 12b are formed on the transparent electrodes 11a and 12a to reduce voltage drop due to the transparent electrodes 11a and 12a having high resistance.

Meanwhile, according to an embodiment of the present invention, the sustain electrode pair 11 and 12 can be composed of a stacked structure of the transparent electrodes 11a 12a and the bus electrodes 11b and 12b or only the bus electrodes 11b and 12b without the transparent electrodes 11a and 12a. Because the latter structure does not use the transparent electrodes 11a and 12a, there is an advantage in that a cost of manufacturing a panel can be decreased. The bus electrodes 11b and 12b used in the structure can be made of various materials such as a photosensitive material in addition to the above-described materials.

A black matrix (BM) 15, which performs a light shielding function of reducing reflection by absorbing external light that is generated from the outside of the upper substrate 10 and a function of improving purity and contrast of the upper substrate 10 may be arranged between the transparent electrodes 11a and 12a and the bus electrodes 11b and 12b of the scan electrode 11 and the sustain electrode 12.

The black matrix 15 according to an embodiment of the present invention is formed in the upper substrate 10 and includes a first black matrix 15 that is formed in a position that is overlapped with a barrier rib 21 and second black matrixes 11c and 12c that are formed between the transparent electrodes 11a and 12a and the bus electrodes 11b and 12b. Here, the first black matrix and the second black matrixes 11c and 12c that are also referred to as a black layer or a black electrode layer may be physically connected to each other when they are formed at the same time in a forming process or may be not physically connected to each other when they are not formed at the same time.

In addition, when they are physically connected to each other, the first black matrix 15 and the second black matrixes 11c and 12c are made of the same material, but when they are physically separated from each other, they may be made of other materials.

It is also possible for bus electrodes 11b and 12b and the barrier rib 21 to perform a light shielding function of reducing reflection by absorbing external light generated from the outside and a function of improving contrast such as the black matrixes, as the bus electrodes 11b and 12b and the barrier rib 21 are dark colored. Otherwise, it is also possible to perform a function of the black matrix by making the overlapped portion viewed from the front looks like black color, as a specific element, for example a dielectric layer 13, formed in the upper substrate 10, and a specific element, for example the barrier rib 21, formed in the lower substrate 20 are complementarily colored.

An upper dielectric layer 13 and a protective film 14 are stacked in the upper substrate 10 in which the scan electrode 11 and the sustain electrode 12 are formed in parallel. Charged particles, which are generated by a discharge are accumulated in the upper dielectric layer 13 and perform a function of protecting the sustain electrode pair 11 and 12. The protective film 14 protects the upper dielectric layer 13 from sputtering of charged particles that are generated at a gas discharge and enhances emission efficiency of a secondary electron.

In addition, the address electrode 22 is formed in an intersecting direction of the scan electrode 11 and the sustain electrode 12. Furthermore, a lower dielectric layer 24 and a barrier rib 21 are formed on the lower substrate 20 in which the address electrode 22 is formed.

In addition, a phosphor layer 23 is formed on the surface of the lower dielectric layer 24 and the barrier rib 21. In the barrier rib 21, a vertical barrier rib 21a and a horizontal barrier rib 21b are formed in a closed manner and the barrier rib 21 physically divides a discharge cell and prevents ultraviolet rays and visible light that are generated by a discharge from leaking to adjacent discharge cells.

Referring to FIG. 1, a filter 100 is preferably formed at the front of the PDP according to the present invention, and the filter 100 may include an external light shielding sheet, an AR (anti-reflection) sheet, a NIR (near infrared) shielding sheet and an EMI shielding sheet, a diffusion sheet and an optical sheet.

In case that the distance between the filter 100 and the PDP is 10 μm to 30 μm, it is possible to effectively shield light incident upon the PDP and to effectively emit light generated from the PDP to the outside. Also, the distance between the filter 100 and the PDP may be 30 μm to 120 μm in order to protect the PDP from the exterior pressure, and an adhesion layer, which absorbs impact, may be formed between the filter 100 and the PDP.

In an embodiment of the present invention, various shapes of barrier rib 21 structure as well as the barrier rib 21 structure shown in FIG. 1 can be used. For example, a differential barrier rib structure in which the vertical barrier rib 21a and the horizontal barrier rib 21b have different heights, a channel type barrier rib structure in which a channel, which can be used as an exhaust passage is formed in at least one of the vertical barrier rib 21a and the horizontal barrier rib 21b, and a hollow type barrier rib structure in which a hollow is formed in at least one of the vertical barrier rib 21a and the horizontal barrier rib 21b, can be used.

In the differential type barrier rib structure, it is more preferable that a height of the horizontal barrier rib 21b is higher than that of the vertical barrier rib 21a and in the channel type barrier rib structure or the hollow type barrier rib structure, it is preferable that a channel or a hollow is formed in the horizontal barrier rib 21b.

Meanwhile, in an embodiment of the present invention, it is described as each of R, G, and B discharge cells is arranged on the same line, but they may be arranged in other shapes. For example, delta type of arrangement in which the R, G, and B discharge cells are arranged in a triangle shape may be also used. Furthermore, the discharge cell may have various polygonal shapes such as a quadrilateral shape, a pentagonal shape, and a hexagonal shape.

Furthermore, the phosphor layer 23 emits light by ultraviolet rays that are generated at a gas discharge and generates any one visible light among red color R, green color G, or blue color B light. Here, inert mixed gas such as He+Xe, Ne+Xe, and He+Ne+Xe for performing a discharge is injected into a discharge space that is provided between the upper/lower substrates 10, 20 and the barrier rib 21.

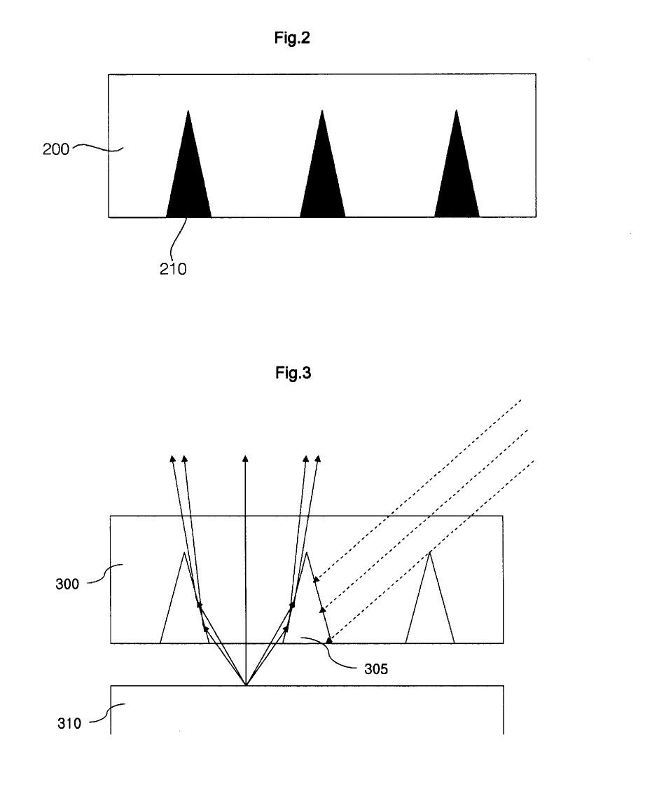

FIG. 2 is a cross-sectional view illustrating a structure of an external light shielding sheet provided in the filter according to an embodiment of the present invention, and the external light shielding sheet includes a base unit 200 and pattern units 210.

The base unit 200 is preferably formed of a transparent plastic material, for example a UV-hardened resin-based material, so that light can smoothly transmit therethrough. Alternately, it is possible to use a hard glass material to protect the front of the PDP.

Referring to FIG. 2, the pattern units 210 may formed as various shapes as well as triangles. The pattern units 210 are formed of a darker material than the base unit 200. For example, the pattern units 210 are formed of a black carbon-based material or covered with a black dye in order to maximize the absorption of external light. Hereinafter, a wider one between top and bottom of the pattern units 210 is referred to as “bottom” of the pattern units 210.

According to FIG. 2, a bottom of the pattern units 210 may be arranged at a panel side, and a top of the pattern units 210 may be arranged at a viewer side. Also, the bottom of the pattern units 210 may also be arranged at the PDP side, and the top of the pattern units 210 may be arranged at the viewer side, contrary to the above arrangement.

In general, an external light source is mostly located over the PDP, and thus external light is diagonally incident on the PDP from the top side and is absorbed in the pattern units 210.

The pattern units 210 may include a light-absorbing particle, and the light-absorbing particle may be a resin particle colored by a specific color. In order to maximize the light absorbing effect, the light-absorbing particle is preferably colored by a black color.

In order to maximize the absorption of external light and to facilitate the manufacture of the light-absorbing particle and the insertion into the pattern units 210, the size of the light-absorbing particle may be 1 μm or more. Also, in case that the size of the light-absorbing particle is 1 μm or more, the pattern units 210 may include the light-absorbing particle 10% weight or more in order to absorb external light more effectively. That is, the light-absorbing particle 10% weight or more of the total weight of the pattern units 210 may be included in the pattern units 210.

FIGS. 3 to 6 are cross-sectional views illustrating a structure of an external light shielding sheet according to an embodiment of the present invention in order to explain optical characteristics in accordance with the structure of the external light shielding sheet.

According to FIG. 3, the refractive index of the pattern units 305, particularly, the refractive index of at least the slanted surface of the pattern units 305 is lower than the refractive index of the base unit 300 in order to enhance the reflectivity of light emitted from the PDP by totally reflecting visible light emitted from the PDP.

As described in the above, external light which reduces the bright room contrast of the PDP is highly likely to be above the PDP. Referring to FIG. 3, according to Snell's law, external light (illustrated as a dotted line) that is diagonally incident upon the external light shielding sheet is refracted into and absorbed by the pattern units 310 which have a lower refractive index than the base unit 300. External light refracted into the pattern units 305 may be absorbed by the light absorption particle.

Also, light (illustrated as a solid line) that is emitted from the PDP 310 for displaying is totally reflected from the slanted surface of the pattern units 305 to the outside, i.e., toward the viewer.

As described above, external light (illustrated as a dotted line) is refracted into and absorbed by the pattern units 305 and light (illustrated as a solid line) emitted from the PDP 310 is totally reflected by the pattern units 305 because the angle between the external light and the slanted surface of the pattern units 305 is greater than the angle between the light emitted from the PDP 310 and the slanted surface of the pattern units 305, as illustrated in FIG. 3.

Therefore, the external light shielding sheet according to the present invention enhances the bright room contrast of the display image by absorbing the external light to prevent the external light from being reflected toward the viewer and by increasing the reflection of light emitted from the PDP 310.

In order to maximize the absorption of external light and the total reflection of light emitted from the PDP 310 in consideration of the angle of external light incident upon the PDP 310, the refractive index of the pattern units 305 is preferably 0.3-1 times higher than the refractive index of the base unit 300. In order to maximize the total reflection of light emitted from the PDP 310 in consideration of the vertical viewing angle of the PDP, the refractive index of the pattern units 305 is preferably 0.3-0.8 times higher than the refractive index of the base unit 300.

As shown in FIG. 3, when a top of the pattern units 305 is arranged at the viewer side and the refractive index of the pattern units 305 is lower than the refractive index of the base unit 300, a ghost phenomenon, that is, the phenomenon that an object is not clearly seen by a viewer may be occurred because light emitted from the PDP is reflected on the slanted surface of the pattern units 305 toward the viewer side.

FIG. 4 illustrates the case that a top of the pattern units 325 is arranged at the viewer side and the refractive index of the pattern units 325 is higher than the refractive index of the base unit 320. Referring to FIG. 4, the refractive index of the pattern units 320 is greater than the refractive index of the base unit 320, according to Snell's law, external light that is incident upon the pattern units 325 is totally absorbed by the pattern units 325.

Therefore, the ghost phenomenon may be reduced when the top of the pattern units 325 is arranged at the viewer side and the refractive index of the pattern units 325 is higher than the refractive index of the base unit 320. The difference between the refractive index of the pattern units 325 and the refractive index of the base unit 320 is preferably 0.05 and more in order to prevent the ghost phenomenon by sufficiently absorbing light emitted from the PDP that is diagonally incident upon the pattern units 325.

When the refractive index of the pattern units 325 is higher than the refractive index of the base unit 320, light transmittance ratio of the external light shielding sheet and bright room contrast may be reduced. Therefore, the difference between the refractive index of the pattern units 325 and the refractive index of the base unit 320 is preferably 0.05 in order to prevent the ghost phenomenon and in order not to considerably reduce light transmittance ratio of the external light shielding sheet. Also, the refractive index of the pattern units 325 is preferably 1.0-1.3 times greater than the refractive index of the base unit 320 to maintain the bright room contrast as well as to prevent the ghost phenomenon.

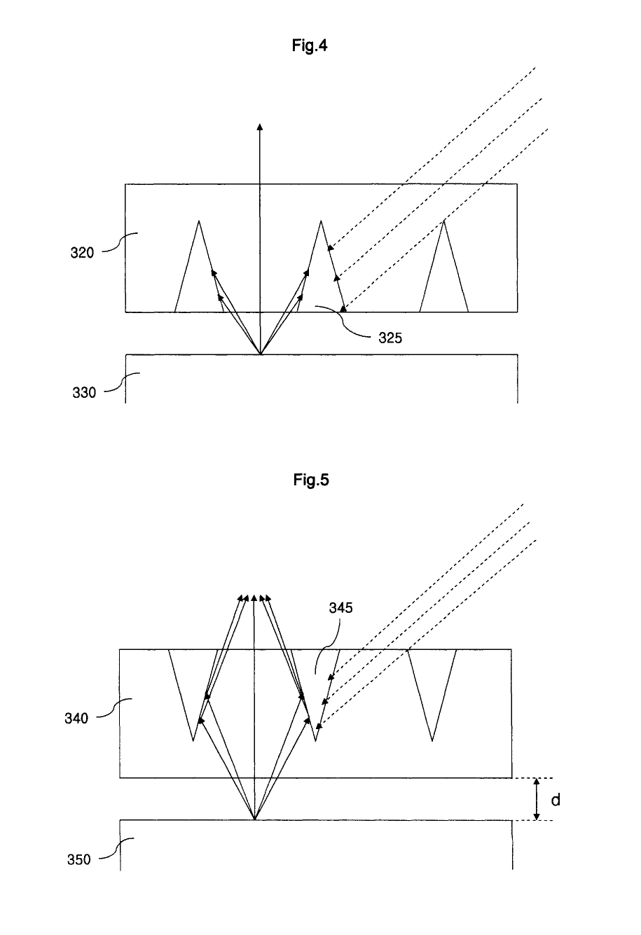

FIG. 5 illustrates the case that a bottom of the pattern units 345 is arranged at the viewer side and the refractive index of the pattern units 345 is lower than the refractive index of the base unit 340. As illustrated in FIG. 5, the external light shielding effect can be enhanced, as external light is allowed to be absorbed in the bottom of the pattern units 345 by arranging the bottom of the pattern units 345 at the viewer side on which external light incident. Also, an opening ratio of the external light shielding sheet can be enhanced because the distance between bottoms of the pattern units 345 may be increased than the distance illustrated in the FIG. 4.

As shown in FIG. 5, light emitted from the PDP 350 may be reflected at the slanted surface of the pattern units 345 and be collected around light from the PDP which passes through the base unit 340. Therefore, the ghost phenomenon may be reduced without considerably lowering the light transmittance ratio of the external light shielding sheet.

The distance d between the PDP 350 and the external light shielding sheet is preferably 1.5 to 3.5 mm in order to prevent the ghost phenomenon as light from the PDP is reflected from the slanted surface of the pattern units 345 and is collected around light from the PDP which passes through the base unit 340.

FIG. 6 illustrates the case that a bottom of the pattern units 365 is arranged at the viewer side and the refractive index of the pattern units 365 is higher than the refractive index of the base unit 360. As illustrated in FIG. 6, light from the PDP which is incident upon the slanted surface of the pattern units 365 may be absorbed in the pattern units 365 because the refractive index of the pattern units 365 is higher than the refractive index of the base unit 360. Therefore, the ghost phenomenon can be reduced, since images are displayed by light from the PDP which passes through the base unit 360.

In addition, the external light absorbing effect can be enhanced, since the refractive index of the pattern units 365 is higher than the refractive index of the base unit 360.

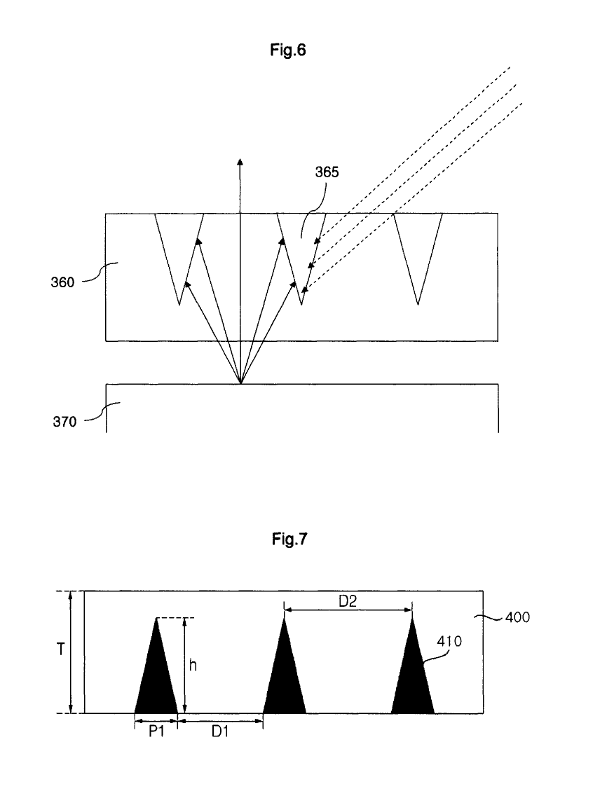

FIG. 7 is a cross sectional view illustrating a structure of an external light shielding sheet included in a filter according to a first embodiment of the present invention. When a thickness T of the external light shielding sheet is 20 μm to 250 μm, the manufacture of the external light shielding sheet can be facilitated and the appropriate light transmittance ratio of the external light shielding sheet can be obtained. The thickness T may be set to 100 μm to 180 μm in order to effectively absorb and shield external light refracted into the pattern units 410 and to enhance the durability of the external light shielding sheet.

Referring to FIG. 7, the pattern units 410 formed on the base unit 400 may be formed as triangles, and more preferably, as equilateral triangles. Also, a bottom width P1 of the pattern units 410 may be 18 μm to 36 μm, and in this case, it is possible to ensure an optimum opening ratio and maximize external light shielding efficiency so that light emitted from the PDP can be smoothly discharged toward an user side.

The height h of the pattern units 410 is set to 80 μm to 170 μm, and thus, it is possible to make a gradient of the slanted surface capable of effectively absorbing external light and reflecting light emitted from the PDP. Also, it is also possible to prevent the pattern units 410 from being short-circuited.

In order to achieve a sufficient opening ratio to display images with optimum luminance through discharge of light emitted from the PDP toward the user side and to provide an optimum gradient of the slanted surface of the pattern units 410 for enhancing the external light shielding efficiency and the reflection efficiency, the distance D1 between a pair of adjacent pattern units may be set to 40 μm to 90 μm, and the distance D2 between tops of the pair of adjacent pattern units may be set to 90 μm to 130 μm.

Due to the above-described reasons, an optimum opening ratio for displaying images can be obtained when the distance D1 is 1.1 to 5 times greater than the bottom width P1 of the pattern units 410. Also, in order to obtain an optimum opening ratio and to optimize the external light shielding efficiency and the reflection efficiency, the distance D1 between bottoms of the pair of adjacent pattern units 410 may be set to be 1.5 to 3.5 greater than the bottom width of the pattern units 410.

When the height h is 0.89 to 4.25 times greater than the distance D1 between the pair of adjacent pattern units, external light diagonally incident upon the external light shielding sheet from above can be prevented from being incident upon the PDP. Also, in order to prevent the pattern units 410 from being short-circuited and to optimize the reflection of light emitted from the PDP, the height h of the pattern units 410 may be set to be 1.5 to 3 times greater than the distance D1 between the pair of adjacent pattern units.

In addition, when the distance D2 between tops of a pair of adjacent pattern units is 1 to 3.25 times greater than the distance D1 between bottoms of a pair of adjacent pattern units, a sufficient opening ratio for displaying images with optimum luminance can be obtained. Also, in order to maximize the total reflection of light emitted from the PDP by the slanted surface of the pattern units 410, the distance D2 between tops of the pair of adjacent pattern units may be set to be 1.2 to 2.5 times greater than the distance D1 between bottoms of the pair of adjacent pattern units.

Although a structure of the external light shielding sheet according to the present invention is explained with the case where the top of the pattern units 410 are arranged at a viewer side, however, it is also applicable to the case when the bottom of the pattern units 410 is arranged at the viewer side.

The moire phenomenon may be generated, as a black matrix, a black layer, a bus electrode and a barrier rib formed in the display panel and a plurality of pattern units 410 that are formed in the external light shielding sheet are overlapped. The moire phenomenon is a pattern of low frequency caused by the interference between periodic images, for example there is a pattern in the shape of wave when mosquito nets are stacked.

In the shape of the front surface of the external light shielding sheet according to the moire phenomenon, the moire phenomenon which is generated as a black matrix, a black layer, a bus electrode and a barrier rib formed in the PDP are overlapped with a plurality of pattern units 410, can be reduced by diagonally forming the plurality of pattern units 410.

For reducing the moire phenomenon, the slanted angle of the plurality of pattern units 410 is preferably 0.5 to 20 degrees. That is, the moire phenomenon may be reduced when the pattern units 410 of the external light shielding sheet are diagonally formed with a black matrix, a black layer, a bus electrode and a barrier rib formed in the PDP at an angle of 0.5 to 20 degrees. Also, in consideration that an external light source is mostly located over the head of a viewer, an appropriate opening ratio is obtained as well as the moire phenomenon is prevented when the slanted angle is 0.5 to 5 degrees, and thus, it is possible to enhance the reflection efficiency of light emitted from the PDP and to effectively shield external light.

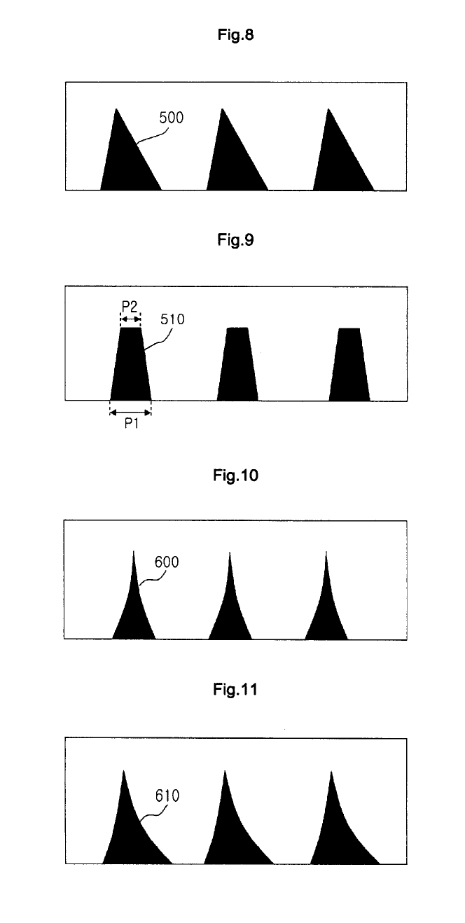

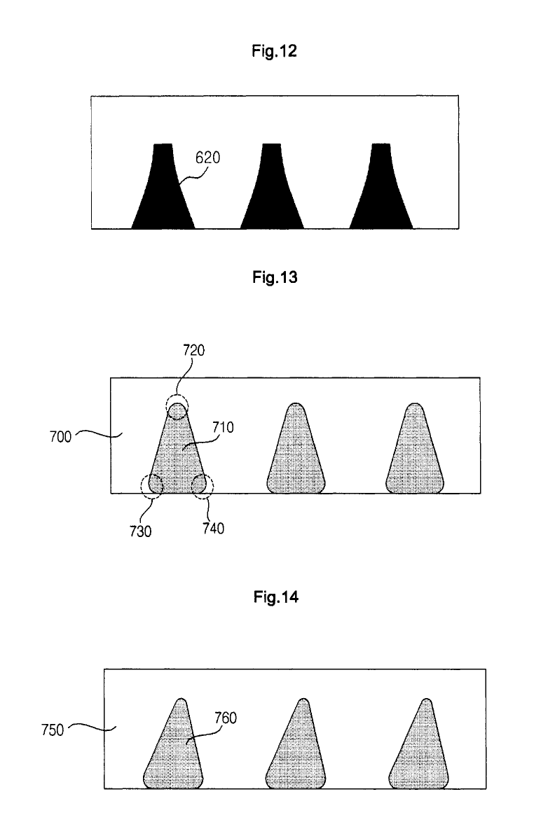

FIGS. 8 to 19 are cross-sectional views illustrating the cross sectional shape of the pattern units of the external light shielding sheet according to embodiments of the present invention.

Referring to FIG. 8, the pattern units 500 may be horizontally asymmetrical. That is, left and right slanted surfaces of the pattern units 500 may have different areas or may form different angles with the bottom. In general, an external light source is located above the PDP, and thus, external light is highly likely to be incident upon the PDP from above within a predetermined angle range. Therefore, in order to enhance the absorption of external light and the reflection rate of light emitted from the PDP, upper slanted surface of two slanted surfaces of the pattern units 500 may be less steep than lower slanted surface.

Referring to FIG. 9, the pattern units 510 may be trapezoidal, and in this case, the top width P2 of the pattern units is less than the bottom width P1 of the pattern unit. Also, the top width P2 of the pattern units 510 may be 10 μm or less, and therefore the slope of the slanted surfaces can be determined according to the relationship between the bottom width P1 so that the absorption of external light and the reflection of light emitted from the PDP can be optimized.

As illustrated in FIGS. 10 to 12, the pattern units 600, 610, 620 may have a curved profile having a predetermined curvature at the left and right slanted surfaces. In this case, the slope angle of the slanted surface of the pattern units 600, 610, 620 is preferably getting gentle in a direction to the top from the bottom.

FIGS. 13 to 15 are cross sectional views illustrating the cross sectional shape of the external light shielding sheet according to the embodiments of the present invention. As shown in the drawings, the edge portion of the pattern units is preferably formed as a curved edge having a predetermined curvature.

Referring to FIG. 13, the cross sectional shape of edge portions 720, 730, 740 of the pattern units 710 may have a curved profile, and also, some of the edge portions 720, 730, 740 may have a curved profile having a predetermined curvature.

A cross sectional shape of at least one of the pattern unit's edge portions 720, 730, 740, for example, a top edge 720 is pointed at the end.

In order to prevent the pattern units 710 from being detached from the base unit 700 when laminating the external light shielding sheet according to the present invention to the film or the glass and to prevent the pattern units 710 from being detached from the base unit 700 due to impact caused by heat or pressure, a radius of curvature of the edge portions 720, 730, 740 of the pattern units 710 is preferably 10 μm to 3 mm.

Referring to FIG. 14, the pattern units 760 may be horizontally asymmetrical. Also, the edge portions of the pattern units 760 may be formed as a curve having a curvature of 10 μm to 3 mm to prevent the pattern units 760 from being detached from the base unit 750.

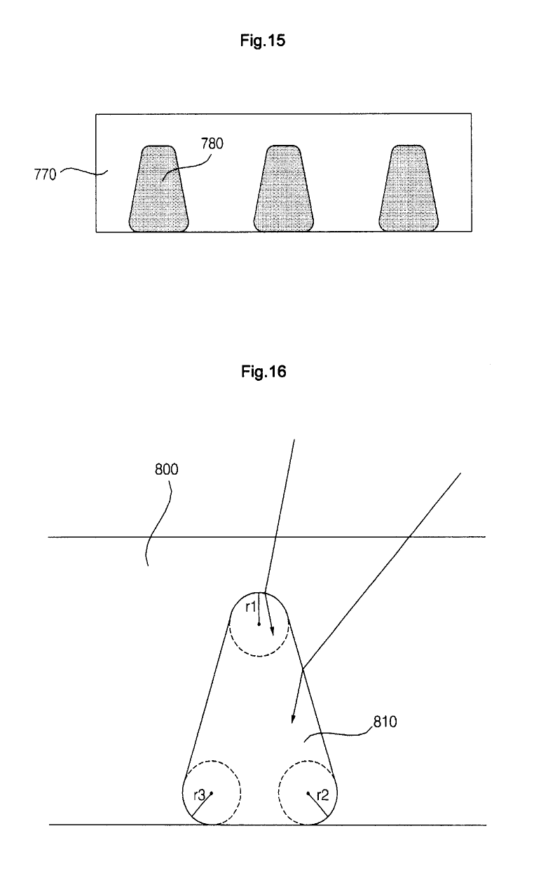

Referring to FIG. 15, the pattern units 780 may be trapezoidal in which a top width is present, and in this case, at least one of four edges may be formed as a curve having a curvature of 10 μm to 3 mm.

Referring to FIG. 16, the edge portions of the pattern units 810 formed in the base unit 800 have curvatures of r₁, r₂, r₃, respectively, and the curvatures r₁, r₂, r₃ are the same or different to each other.

Also, the pattern units 810 may absorb external light incident upon the PDP at various incident angles by forming the top edge of the pattern units 810 as a curved profile.

In order to prevent the pattern units 810 from being detached from the base unit 800 because of laminating or impact caused by heat or pressure as well as to effectively absorb external light, a radius of curvature r₁, r₂, r₃ of the edge portions, in particular a radius of curvature r₁, r₂, r₃ of the top edge portion is preferably 100 μm to 800 μm.

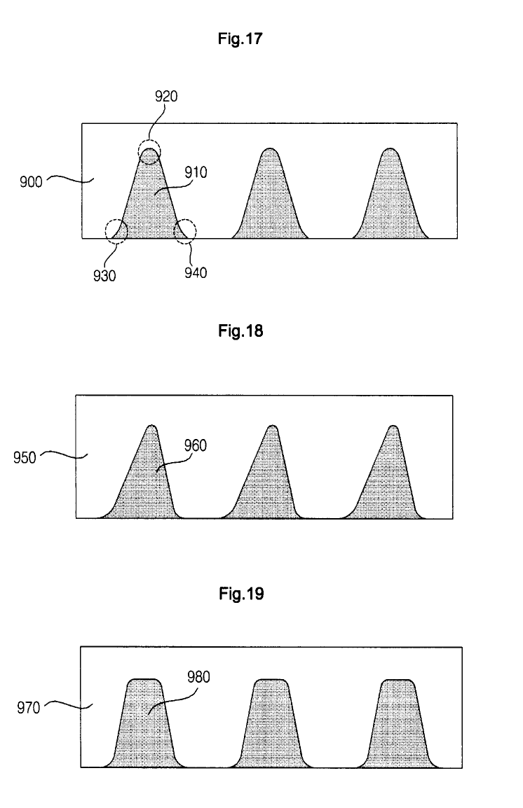

FIGS. 17 to 19 are cross sectional views illustrating the cross sectional shape of the pattern units of the external light shielding sheet according to further another embodiments of the present invention. As illustrated in the drawings, the bottom edge portion of the pattern unit may be formed as a curve expanding to the outside.

Referring to FIG. 17, the edge portions 920, 930, 940 of the pattern units 910 may be a curved profile having a predetermined curvature, and some of the bottom edge portions 930, 940 of the pattern unit 910 may also be formed as a curve expanding to the outside.

For the external light shielding sheet as illustrated in FIG. 17, the outer radius of curvature of the bottom edge portions 930, 940 of the pattern units 910 may have 10 μm to 3 mm in order to prevent the pattern units 910 from being detached from the base unit 900 when laminating the external light shielding sheet according to the present invention to the film or the glass and to prevent the pattern units 910 from being detached from the base unit 900 due to impact caused by heat or pressure.

Referring to FIG. 18, the pattern units 960 may be horizontally asymmetrical. Also, the edge portions of the bottom of the pattern units 960 may be formed as a curve expanding to the outside. The outer radius of curvature of the bottom edge portions may have a curvature of 10 μm to 3 mm to prevent the pattern units 960 from being detached from the base unit 950.

Referring to FIG. 19, the pattern units 980 may be trapezoidal in which a top width is present, and in this case, the bottom edge portions may be formed as a curve expanding to the outside and the outer radius of curvature of the bottom edge portions may have a curvature of 10 μm to 3 mm to prevent the pattern units 980 from being detached from the base unit 970.

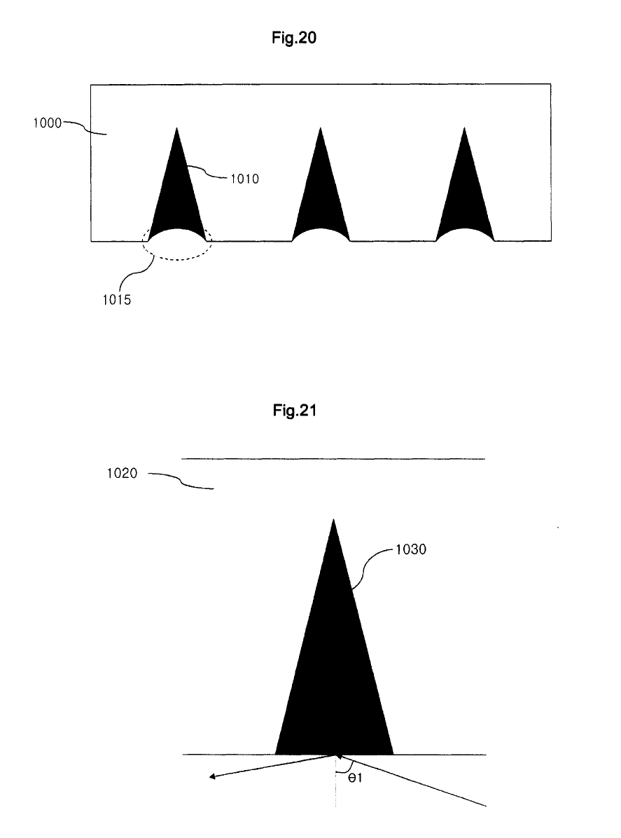

FIG. 20 is a cross sectional view illustrating the shape of the pattern units in which groove is formed on a bottom of the pattern units according to an embodiment of the present invention.

As shown in FIG. 20, bleeding phenomenon of the image that is generated as light emitted from the PDP is reflected on the bottom 1015 of the pattern units can be reduced by forming a center of the bottom 1015 of the pattern units as a round hole or a concave. Also, when the external light shielding sheet is attached to another functional sheet or the PDP, adhesive force can be enhanced as the area of the contact portion is increased.

That is, the pattern units 1010 having a concave bottom 1015 may be formed by forming the pattern units 1010 in which the height of the center area is lower than the height of the outer most contour.

The pattern units 1010 may be formed by filling light-absorbing materials into grooves formed in the base unit 1000, wherein some of the grooves formed in the base unit 1000 may be filled by the light-absorbing materials and the rest of the grooves may be left as an occupied space. Therefore, the bottom 1015 of the pattern units 1010 may be a concave shape in which the center area is depressed into the inside.

As shown in FIG. 21, light that is emitted from the PDP and diagonally incident upon the bottom of the pattern units 1030 may be reflected toward the PDP, when the bottom of the pattern units 1030 is flat. As images, to be displayed at a specific position by light reflected toward the PDP, are displayed around the specific position, and thus, the sharpness of the display images may be reduced because the bleeding phenomenon is occurred.

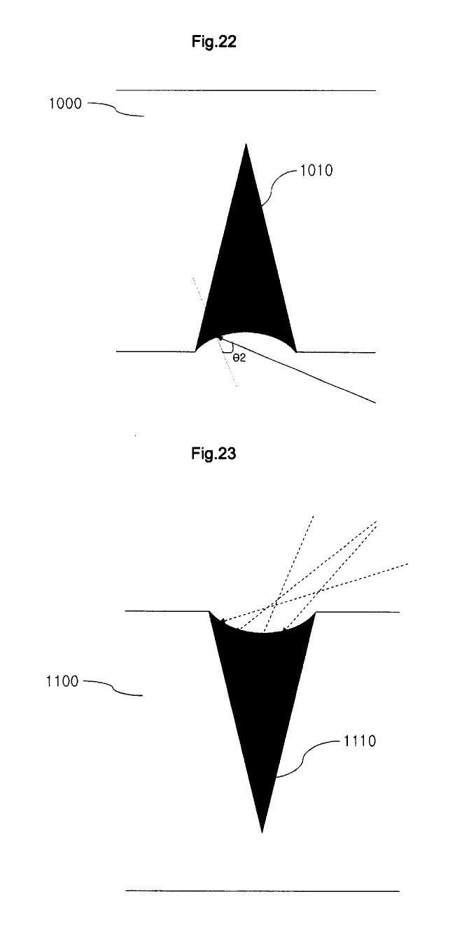

Referring to FIG. 22, the incident angle θ2 that is diagonally incident upon the bottom of the pattern units 1010 having a depressed shape is smaller than the incident angle θ1 that is incident upon the bottom of the pattern units 1030 having a flat shape illustrated in FIG. 21. Therefore, the PDP light that is reflected on the bottom of the pattern units 1030 having a flat shape may be absorbed into the pattern units 1010 at the bottom of the pattern units 1010 having a depressed shape. Therefore, the sharpness of the display images may be enhanced by reducing the bleeding phenomenon of the display images.

FIG. 23 is a cross sectional view illustrating a structure of the external light shielding sheet with the pattern units 1110 having a concave shape at the bottom, which is arranged at a viewer side.

Referring to FIG. 23, incident angle range of external light that is absorbed in the bottom of the pattern units 1110 can be increased by forming the bottom of the pattern units 1110 as a concave. That is, when the bottom of the pattern units 1110 is formed as a concave, the incident angle of external light that is incident upon the bottom of the pattern units 1110 may be increased, and thus, the absorption of external light can be increased.

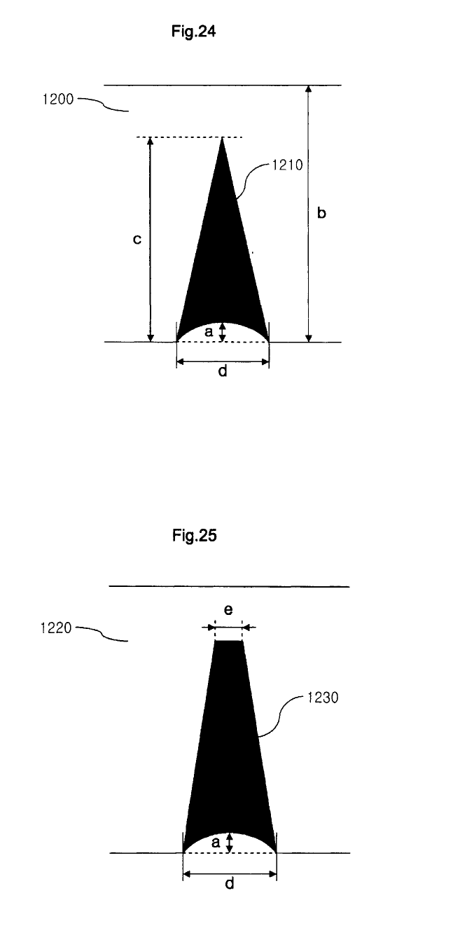

FIG. 24 is a cross sectional view illustrating the shape of the pattern units having a concave shape at the bottom according to the embodiment of the present invention. Table 1 presents experimental results about the bleeding phenomenon of the display images according to the depth a of the groove of the width d of the pattern units 1210, that is, Table 1 presents experimental results about whether the bleeding phenomenon of images is reduced or not compared with the PDP in which the external light shielding panel having flat pattern units is arranged.

TABLE 1

| Depth (a) of | Bottom width (d) of | Reduction of bleeding |
|---|---|---|
| groove | pattern unit | phenomenon |
| 0.5 μm | 27 μm | x |
| 1.0 μm | 27 μm | x |
| 1.5 μm | 27 μm | ∘ |
| 2.0 μm | 27 μm | ∘ |
| 2.5 μm | 27 μm | ∘ |
| 3.0 μm | 27 μm | ∘ |
| 3.5 μm | 27 μm | ∘ |
| 4.0 μm | 27 μm | ∘ |
| 4.5 μm | 27 μm | ∘ |
| 5.0 μm | 27 μm | ∘ |
| 5.5 μm | 27 μm | ∘ |
| 6.0 μm | 27 μm | ∘ |
| 6.5 μm | 27 μm | ∘ |
| 7.0 μm | 27 μm | ∘ |
| 7.5 μm | 27 μm | x |
| 8.0 μm | 27 μm | x |
| 9.0 μm | 27 μm | x |
| 9.5 μm | 27 μm | x |

As described in Table 1, the sharpness of the display images may be enhanced by reducing the bleeding phenomenon of the display images, when a depth a of the depressed groove formed in the bottom of the pattern units 1210 is 1.5 μm to 7.0 μm.

Also, the depth a formed in the bottom of the pattern units 1210 is preferably 2 μm to 5 μm in consideration of the protection of the pattern units 1210 from the exterior pressure, and the manufacturing facilitation of the pattern units 1210.

As described in the above with reference to FIG. 7, it is possible to ensure an optimum opening ratio and maximize external light shielding efficiency, when a bottom width d of the pattern units 1210 is 18 μm to 35 μm, and thus, the bottom width d of the pattern units 1210 is preferably set to be 3.6 to 17.5 times greater than a depth a of a groove formed on the bottom of the pattern units 1210.

Meanwhile, it is possible to form a gradient of the slanted surface capable of optimizing the absorption of external light and the reflection of light emitted from the PDP, when a height c of the pattern units 1210 is 80 μm to 170 μm, and thus, the height c of the pattern units 1210 is preferably set to be 16 to 85 times greater than the depth a of the groove formed on the bottom of the pattern units 1210 between the pair of adjacent pattern units.

Also, the thickness b of the external light shielding sheet is preferably set to be 20 to 90 times greater than the depth a of the groove formed in the bottom of the pattern units 1210, because it is possible to obtain the appropriate transmittance of light emitted from the PDP, the absorption and the shielding as well as the durability of the external light shielding sheet when the thickness b of the external light shielding sheet is 100 μm to 180 μm.

Referring to FIG. 25, the pattern units 1230 may be trapezoidal, and in this case, the top width e of the pattern units is preferably less than the bottom width d of the pattern units. Also, when the top width e of the pattern units 1230 may be 10 μm or less, and the slope of the slanted surfaces can be determined according to the relationship between the bottom width d so that the absorption of external light and the reflection of light emitted from the PDP can be optimized. In this case, the relationship between the top width e of the pattern units 1230 and the bottom width d of the pattern units 1230 may be the same as illustrated in FIG. 24.

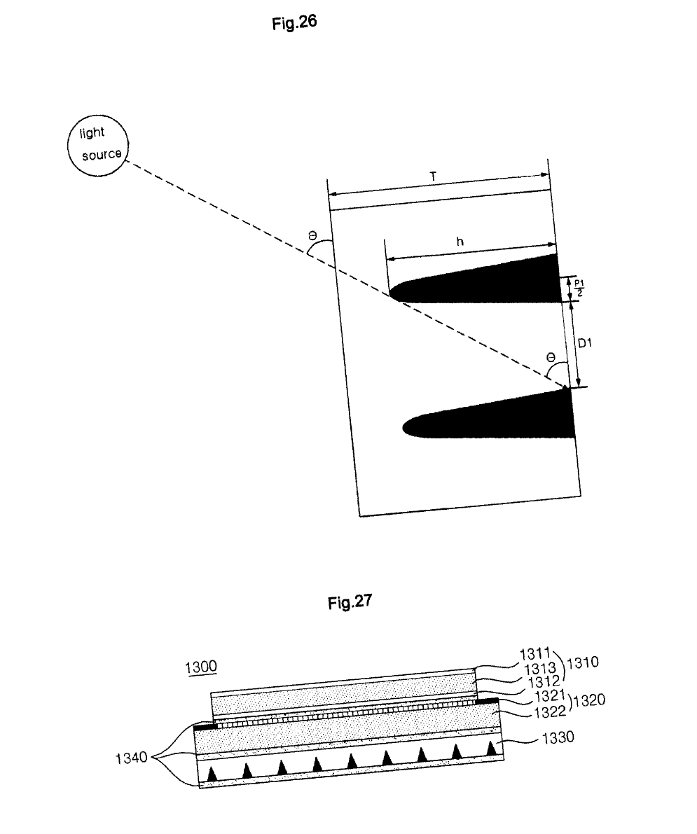

FIG. 26 is a cross sectional view illustrating a structure of the external light shielding sheet to explain the relation between a thickness of the external light shielding sheet and a height of the pattern units.

Referring to FIG. 26, the thickness T of the external light shielding sheet is preferably set to 100 μm to 180 μm in order to obtain appropriate transmittance ratio of visible light emitted from the PDP for displaying images as well as to enhance the durability of the external light shielding sheet including the pattern units.

When the height h provided in the external light shielding sheet is 80 μm to 170 μm, the manufacture of the external light shielding sheet can be facilitated, the appropriate opening ratio of the external light shielding sheet can be obtained, and the function of shielding external light and the function of reflecting light emitted from the PDP can be maximized.

The height h of the pattern units can be varied according to the thickness T of the external light shielding sheet. In general, external light that considerably affects the bright room contrast of the PDP is highly likely to be incident upon the PDP from the above. Therefore, in order to effectively shield external light with an angle θwithin a predetermined range, the height h of the pattern units is preferably within a predetermined percentage of the thickness T of the external light shielding sheet.

As the height h of the pattern units increases, the thickness of the base unit, which is top region of the pattern units, decreases, and thus, dielectric breakdown may occur. On the other hand, as the height h of the pattern units decreases, more external light is likely to be incident upon the PDP at various angles within a predetermined range, and thus the external light shielding sheet may not properly shield the external light.

Table 2 presents experimental results about the dielectric breakdown and the external light shielding effect of the external light shielding sheet according to the thickness T of the external light shielding sheet and the height h of the pattern units.

TABLE 2

| Thickness (T) of | | | |
|---|---|---|---|
| external light | Height (h) of | Dielectric | External light |
| shielding sheet | pattern units | breakdown | shielding |
| 120 μm | 120 μm | ∘ | ∘ |
| 120 μm | 115 μm | Δ | ∘ |
| 120 μm | 110 μm | x | ∘ |
| 120 μm | 105 μm | x | ∘ |
| 120 μm | 100 μm | x | ∘ |
| 120 μm | 95 μm | x | ∘ |
| 120 μm | 90 μm | x | ∘ |
| 120 μm | 85 μm | x | Δ |
| 120 μm | 80 μm | x | Δ |
| 120 μm | 75 μm | x | Δ |
| 120 μm | 70 μm | x | Δ |
| 120 μm | 65 μm | x | Δ |
| 120 μm | 60 μm | x | Δ |
| 120 μm | 55 μm | x | Δ |
| 120 μm | 50 μm | x | x |

Referring to Table 2, when the thickness T of the external light shielding sheet is 120 μm or more, and the height h of the pattern units 115 μm or more, the pattern units are highly likely to dielectric breakdown, thereby increasing defect rates of the product. When the height h of the pattern units 115 μm or less, the pattern units are less likely to dielectric breakdown, thereby reducing defect rates of the external light shielding sheet. However, when the height h of the pattern units is 85 μm or less, the shielding efficiency of external light may be reduced, and when the height h of the pattern units is 60 μm or less, external light is likely to be directly incident upon the PDP. Therefore, when the height h of the pattern units is 90 μm to 110 μm, the shielding efficiency of the external light shielding sheet may be increased as well as the defect rates of the external light shielding sheet may be decreased.

In addition, when the thickness T of the external light shielding sheet is 1.01 to 2.25 times greater than the height h of the pattern units, it is possible to prevent the top portion of the pattern units from dielectrically breaking down and to prevent external light from being incident upon the PDP. Also, in order to prevent dielectric breakdown and infiltration of external light into the PDP, to increase the reflection of light emitted from the PDP, and to secure optimum viewing angles, the thickness T the external light shielding sheet may be 1.01 to 1.5 times greater than the height h of the pattern units.

Table 3 presents experimental results about the occurrence of the moire phenomenon and the external light shielding effect of the external light shielding sheet according to different pattern unit bottom width P1-to-bus electrode width ratios, when the width of the bus electrode is 70 μm.

TABLE 3

| Bottom width of | | |
|---|---|---|
| pattern units/Width | | External light |
| of bus electrodes | Moire | shielding |
| 0.10 | Δ | x |
| 0.15 | Δ | x |
| 0.20 | x | Δ |
| 0.25 | x | ∘ |
| 0.30 | x | ∘ |
| 0.35 | x | ∘ |
| 0.40 | x | ∘ |
| 0.45 | Δ | ∘ |
| 0.50 | Δ | ∘ |
| 0.55 | ∘ | ∘ |
| 0.60 | ∘ | ∘ |

Referring to Table 3, when the bottom width of the pattern units is 0.2 to 0.5 times greater than the bus electrode width, the moire phenomenon can be reduced as well as external light incident upon the PDP can be reduced. Also, in order to prevent the moire phenomenon, to effectively shield external light, and to secure a sufficient opening ratio for discharging light emitted from the PDP, the bottom width of the pattern units is preferably 0.25 to 0.4 times greater than the bus electrode width.

Table 4 presents experimental results about the occurrence of the moire phenomenon and the external light shielding effect according to different pattern unit bottom width of the external light shielding sheet-to-vertical barrier rib width ratios, when the width of the vertical barrier rib is 50 μm.

TABLE 4

| Bottom widths of | | |
|---|---|---|
| pattern units/Top width | | External light |
| of vertical barrier ribs | Moire | shielding |
| 0.10 | ∘ | x |
| 0.15 | Δ | x |
| 0.20 | Δ | x |
| 0.25 | Δ | x |
| 0.30 | x | Δ |
| 0.35 | x | Δ |
| 0.40 | x | ∘ |
| 0.45 | x | ∘ |
| 0.50 | x | ∘ |
| 0.55 | x | ∘ |
| 0.60 | x | ∘ |
| 0.65 | x | ∘ |
| 0.70 | Δ | ∘ |
| 0.75 | Δ | ∘ |
| 0.80 | Δ | ∘ |
| 0.85 | ∘ | ∘ |
| 0.90 | ∘ | ∘ |

Referring to Table 4, when the bottom width of the pattern units is 0.3 to 0.8 times greater than the top width of the vertical barrier rib, the moire phenomenon can be reduced as well as external light incident upon the PDP can be reduced. Also, in order to prevent the moire phenomenon, to effectively shield external light, and to secure a sufficient opening ratio for discharging light emitted from the PDP, the bottom width of the pattern units is preferably 0.4 to 0.65 times greater than the top width of the vertical barrier rib.

FIGS. 27 to 30 are cross-sectional views illustrating a structure of a filter according to embodiments of the present invention. The filter formed at a front of the PDP may include an anti-reflection (AR)/near infrared (NIR) sheet, an electromagnetic interference (EMI) sheet, an external light shielding sheet and an optical sheet.

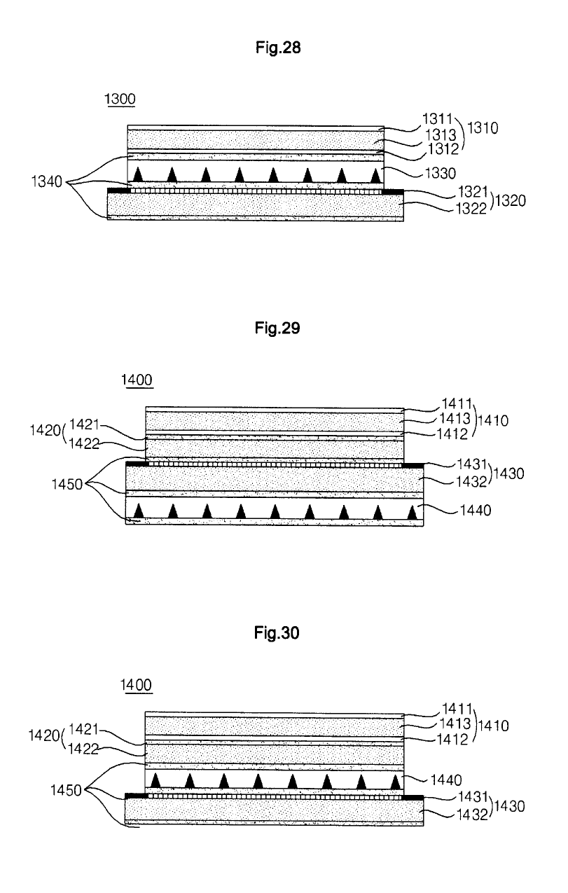

Referring to FIGS. 27 and 28, an anti-reflection (AR) layer 1311 which is attached onto a front surface of the base sheet 1313 and reduces glare by preventing the reflection of external light from the outside is attached onto the AR/NIR sheet 1310, and a near infrared (NIR) shielding layer 1312 which shields NIR rays emitted from the PDP so that signals provided by a device such as a remote control which transmits signals using infrared rays can be normally transmitted is attached onto a rear surface of the AR/NIR sheet.

The electromagnetic interference (EMI) sheet 1320 includes an electromagnetic interference (EMI) layer 1321 which is attached onto a front surface of the base sheet 1322 which is formed of a transparent plastic material and shields EMI emitted from the PDP so that the EMI can be prevented from being released to the outside. Here, the electromagnetic interference (EMI) layer 1321 is generally formed of a conductive material in a mesh form. An invalid display area of the electromagnetic interference (EMI) sheet 1320 where no image is displayed is covered with a conductive material in order to properly ground the electromagnetic interference (EMI) layer.

In general, an external light source is mostly located over the head of a viewer regardless of an indoor or outdoor environment. The external light shielding sheet 1330 is attached thereto so that external light is effectively shielded and thus black images of the PDP can be rendered even blacker.

An adhesive layer 1340 is interposed between the AR/NIR sheet 1310, the electromagnetic interference (EMI) sheet 1320 and the external light shielding sheet 1330, so that the sheets 1310, 1320, 1330 and the filter 1300 can be firmly attached onto the front surface of the PDP. Also, the base sheets interposed between the sheets 1310, 1320, 1330 are preferably made of the same material in order to facilitate the manufacture of the filter 1300.

Meanwhile, according to FIG. 27, the AR/NIR sheet 1310, the electromagnetic interference (EMI) sheet 1320, and the external light shielding sheet 1330 are sequentially stacked. Alternatively, the AR/NIR sheet 1310, the external light shielding sheet 1330 and the electromagnetic interference (EMI) sheet 1320 may be sequentially stacked, as illustrated in FIG. 28. The order in which the AR/NIR sheet 1310, the electromagnetic interference (EMI) sheet 1320 and the external light shielding sheet 1330 are stacked is not restricted to those set forth herein. Also, at least one layer of the illustrated sheets 1310, 1320, 1330 can be omitted.

Referring to FIGS. 29 and 30, a filter 1400 disposed at the front surface of the PDP may further include an optical sheet 1420 as well as an AR/NIR sheet 1410, an electromagnetic interference (EMI) sheet 1430 and an external light shielding sheet 1440. The optical sheet 1420 enhances the color temperature and luminance properties of light from the PDP, and an optical sheet layer 1421 which is formed of a dye and an adhesive is stacked on a front or rear surface of the base sheet 1422 which is formed of a transparent plastic material.

At least one of the base sheets illustrated in FIGS. 27 to 30 may be abbreviated, and at least one of the base sheets may be formed of a hard glass instead of being formed of a plastic material, so that the protection of the PDP can be enhanced. It is preferable that the glass is formed at a predetermined spacing apart from the PDP.

In addition, the filter according to the present invention may further include a diffusion sheet. The diffusion sheet serves to diffuse light incident upon the PDP to maintain the uniform brightness. Therefore, the diffusion sheet may widen the vertical viewing angle and conceal the patterns formed on the external light shielding sheet by uniformly diffusing light emitted from the PDP. Also, the diffusion sheet may enhance the front luminance as well as antistatic property by concentrating light in the direction corresponding to the vertical viewing angle.

As a diffusion sheet, a transmissive diffusion film or a reflective diffusion film can be used. The diffusion sheet may have the mixed form that small glass particles are mixed in the base sheet of polymer material. Also, PMMA may be used as a base sheet of the diffusion film. When PMMA is used as a base sheet of the diffusion film, it can be used in large display devices because thermal resistance of the base sheet is good enough despite of it's thick thickness.

According to the present invention, it is possible to effectively realize black images and enhance bright room contrast by arranging the external light shielding sheet, which absorbs and shields external light from the outside, at the front of the display panel. Also, it is possible to prevent the pattern units from being detached from the base unit due to external impact and to effectively shield external light incident upon the PDP from various directions by forming the edge portions or the bottom of the pattern units as a curve having a predetermined curvature.

While the present invention has been particularly shown and described with reference to exemplary embodiments thereof, it will be understood by those of ordinary skill in the art that various changes in form and details may be made therein without departing from the spirit and scope of the present invention as defined by the following claims. It is, therefore, intended that such changes and modifications be covered by the following claims.

What is claimed is;

1. A filter, comprising:
an external light shielding sheet which comprises a base unit and a plurality of pattern units that are formed on the base unit and absorb external light, wherein a cross sectional shape of at least one of the pattern unit's edges is a curve.

2. The filter of claim 1, wherein a cross sectional shape of at least one of the pattern unit's edges has a radius of curvature of 10 μm to 3 mm.

3. The filter of claim 1, wherein a cross sectional shape of at least one of the pattern unit's edges has a radius of curvature of 100 μm to 800 μm.

4. The filter of claim 1, wherein a cross sectional shape of at least one of the pattern unit's edges is a curve expanding to the outside.

5. The filter of claim 1, wherein a refractive index of the pattern units is 0.3 to 1 times greater than a refractive index of the base unit.

6. The filter of claim 1, wherein a refractive index of the pattern units is higher than a refractive index of the base unit, and a difference between a refractive index of the pattern units and a refractive index of the base unit is 0.05 to 0.3.

7. The filter of claim 1, wherein a refractive index of the pattern units is 1.0 to 1.3 times greater than a refractive index of the base unit.

8. The filter of claim 1, wherein bottoms of the pattern units are wider than tops of the pattern units and the bottoms of the pattern units are closer than the tops of the pattern units to a display panel.

9. The filter of claim 1, wherein a thickness of the external light shielding sheet is 1.01 to 2.25 times greater than a height of the pattern units.

10. The filter of claim 1, wherein wherein a distance between a pair of adjacent pattern units is 1.1-5 times greater than a bottom width of the pattern units.

11. The filter of claim 1, wherein a height of the pattern units is 0.89 to 4.25 times greater than a distance between bottoms of a pair of adjacent pattern units

12. The filter of claim 1, wherein a distance between tops of a pair of adjacent pattern units is 1 to 3.25 times greater than a distance between bottoms of a pair of adjacent pattern units.

13. The filter of claim 1, wherein a cross sectional shape of at least one of the pattern unit's edges is pointed at the end.

14. A filter, comprising:
an external light shielding sheet which comprises a base unit and a plurality of pattern units that are formed on the base unit and absorb external light, wherein a groove is formed at a bottom of the pattern units.

15. The filter of claim 14, wherein a refractive index of the pattern units is 0.3 to 1 times greater than a refractive index of the base unit.

16. The filter of claim 14, wherein a refractive index of the pattern units is higher than a refractive index of the base unit, and a difference between a refractive index of the pattern units and a refractive index of the base unit is 0.05 to 0.3.

17. The filter of claim 14, wherein a refractive index of the pattern units is 1.0 to 1.3 times greater than a refractive index of the base unit.

18. a plasma display panel (PDP); and
a filter which is disposed at a front of the PDP,
wherein the filter comprises:
external light shielding sheet which includes a base unit and a plurality of pattern units that are formed on the base unit and absorb external light, and wherein a cross sectional shape of at least one of the pattern unit's edges has a radius of curvature of 10 μm to 3 mm.

19. The plasma display device of claim 18, wherein a refractive index of the pattern units is higher than a refractive index of the base unit, and a difference between a refractive index of the pattern units and a refractive index of the base unit is 0.05 to 0.3.

20. The plasma display device of claim 18, wherein a cross sectional shape of at least one of the pattern unit's edges is pointed at the end.
